(19) United States
(12) Patent Application Publication
(10) Pub. No.: US 2017/0266818 A1
(43) Pub. Date: Sep. 21, 2017

(54) ROBOT AND ROBOT HAND HAVING SURFACE MATCHING FUNCTION

(71) Applicant: FANUC CORPORATION, Yamanashi (JP)

(72) Inventor: Ryou Matsumoto, Yamanashi (JP)

(73) Assignee: FANUC CORPORATION, Yamanashi (JP)

(21) Appl. No.: 15/460,989

(22) Filed: Mar. 16, 2017

(30) Foreign Application Priority Data
Mar. 17, 2016 (JP) 2016-054152

(51) Int. Cl. B25J 17/02; B25J 15/06

(52) U.S. Cl. CPC B25J 17/0275; B25J 15/0608; Y10S 901/29; Y10S 901/40

(57) ABSTRACT

A robot hand and a robot having the robot hand, the robot hand having a mechanism configured to appropriately carry out surface matching between an electrical magnet and an adsorbed surface of a workpiece, corresponding to the posture of the adsorbed surface. The robot hand has: a hand base; a holder attached to the hand base; a spherical bearing arranged in the holder so that a rotational center of the spherical bearing is positioned on a hand center axis; a connecting member attached to the holder via the spherical bearing, the connecting member having a protruding portion which protrudes from the holder in a direction opposed to the hand base; a holder base fixed to an attachment surface opposed to an adsorbing surface of the electrical magnet; and a posture restoring member for restoring the posture of the holder base so that the holder base represents a neutral posture.

### BACKGROUND OF THE INVENTION

1. Field of the Invention

The present invention relates to a robot hand configured to hold a workpiece by using an adsorbing surface of an electrical magnet, and relates to a robot having the robot hand.

2. Description of the Related Art

When an object (workpiece) to be conveyed is conveyed by using a robot, opening-closing claws (fingers), a vacuum pad or an electrical magnet are known as a hand of the robot. As a relevant prior art document, JP H10-156779 A discloses a robot hand in which: a vacuum chuck is fixed to one end of a connecting member; the connecting member is held by a holder member via a spherical bearing; and the holder member is attached to a holder arm.

Further, JP H06-190771 A discloses a robot hand having: a support plate and a support rod configured to vertically move relative to a joint box; an electrical magnet and a workpiece hold plate arranged on the support late and the support rod, configured to hold a workpiece and swing while using a front end of the support rod as a fulcrum; and a bellows arranged between the support plate and the workpiece hold plate, and configured to correct the posture of the workpiece so that the workpiece is in a horizontal state after the workpiece hold plate holds the workpiece.

In general, when a robot hand is a vacuum suction type, an expensive vacuum generator is necessary, and thus a system including a robot becomes costly. Further, also when an air actuator or an electrical actuator is used to correct the posture of the held workpiece, a system including the actuator is costly.

### SUMMARY OF THE INVENTION

An object of the present invention is to provide a robot hand and a robot having the robot hand, the robot hand having a mechanism configured to appropriately carry out surface matching between an electrical magnet and an adsorbed surface of a workpiece, corresponding to the posture (or inclination) of the adsorbed surface, without using an expensive apparatus such as an actuator or a vacuum generator.

One aspect of the present invention provides a robot hand configured to match an adsorbing surface of an electrical magnet with an adsorbed surface of a workpiece and adsorb the workpiece so as to hold the workpiece, the robot hand comprising: a hand base; a holder attached to the hand base; a spherical bearing arranged in the holder so that a rotational center of the spherical bearing is positioned on a hand center axis of the hand; a connecting member attached to the holder via the spherical bearing so that a posture of the connecting member relative to the holder can be changed, the connecting member having a protruding portion which protrudes from the holder in a direction opposed to the hand base with respect to the holder; and a holder base fixed to an attachment portion of the electrical magnet opposed to the adsorbing surface, wherein the protruding portion of the connecting member is attached to the holder base so that the connecting member is integrated with the electrical magnet via the holder base, and wherein a posture restoring member is provided to the holder base, the posture restoring member being configured to restore a posture of the holder base so that the holder base represents a neutral posture in which a center axis of the protruding portion of the connecting member coincides with the hand center axis.

In a preferred embodiment, the posture restoring member has a plate spring. In this regard, the posture restoring member may have a plurality of plate springs configured to generate a restoring force in either of eight directions different from each other.

Another aspect of the present invention provides a robot comprising the robot hand as described above.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is a perspective view of a robot hand according to a preferred embodiment of the present invention;

FIG. 2 is a sectional side view of the robot hand of FIG. 1; and

FIG. 3 is a flowchart showing an example of a procedure for handling a workpiece by using the robot hand of FIG. 1.

### DETAILED DESCRIPTION

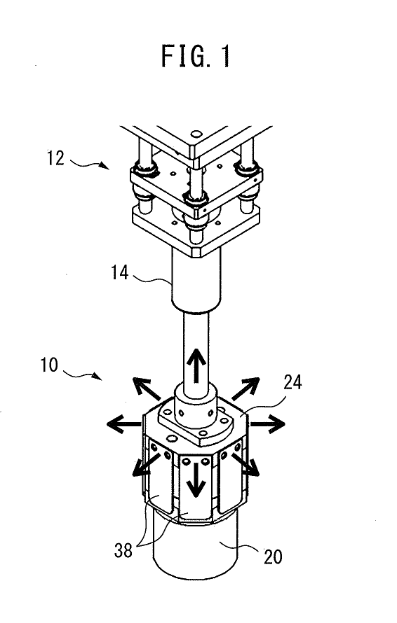

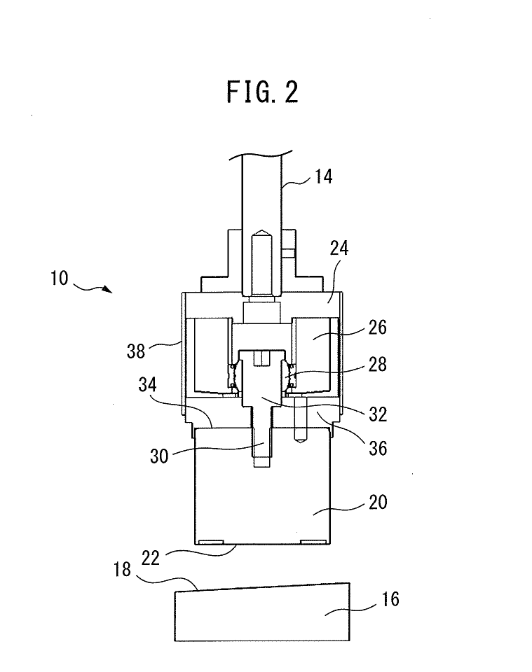

FIG. 1 is a perspective view of a robot hand 10 according to a preferred embodiment of the present invention, and FIG. 2 is a sectional side view of robot hand 10 along a center axis thereof. Robot hand 10 of FIG. 1 is attached to a front end of a robot (or a robot arm) 12, such as a multi-joint robot, via a rotatable wrist axis 14. Robot hand 10 is configured to hold and convey an object (or a workpiece) 16, which is formed from a material, such as a metal, capable of being adsorbed by a magnetic force, by matching an adsorbing surface 22 of an electrical magnet 20 with an adsorbed surface 18 of workpiece 16 so as to adsorb workpiece 16.

In detail, robot hand 10 has a hand base 24 connected to wrist axis 14; a holder 26 attached to hand base 24; a spherical bearing 28 arranged in holder 26 so that a rotational center of spherical bearing 28 is positioned on a hand center axis of hand 10; a connecting member 32 attached to holder 26 via spherical bearing 28 so that a posture of connecting member 32 relative to holder 26 can be changed, connecting member 32 having a protruding portion 30 which protrudes from holder 26 in a direction opposed to hand base 24 with respect to holder 26; and a holder base 36 fixed to an attachment portion (or an attachment surface) 34 of electrical magnet 20 opposed to adsorbing surface 22.

Protruding portion 30 of connecting member 32 is attached to holder base 36 so that connecting member 32 is integrated with electrical magnet 20 via holder base 36. In the embodiment of FIG. 2, Protruding portion 30 of connecting member 32 extends through holder base 36, and is threadably connected to a generally center portion of attachment surface 34 of electrical magnet 20.

A posture restoring member 38 is provided to holder base 36, the posture restoring member being configured to restore a posture of connecting member 32 (or holder base 36) so that connecting member 32 (holder base 36) represents a neutral posture in which a center axis of protruding portion 30 of connecting member 32 coincides with the hand center axis. As posture restoring member 38, a means for generating a restoring force without using an actuator such as an air actuator or an electrical actuator is preferably used. For example, it is preferable that a plate spring, a coil spring or a disc spring (in particular, the plate spring) be used as posture restoring member 38.

It is preferable that a plurality of posture restoring members 38 (in particular, a plurality of plate springs) be used so that a restoring force is generated in either of different directions. In the illustrated embodiment, in a plane parallel to adsorbing surface 22 of electrical magnet 20 (or perpendicular to the hand center axis), eight plate springs 38 are attached to outer lateral sides of holder base 36 and holder 26 (or holder base 24) (e.g., at regular angular intervals of 45 degrees), so that a restoring force is applied in eight directions radially extending from the hand center axis (e.g., at regular angular intervals of 45 degrees). In this regard, when the plurality of plate springs is used, the number thereof is not limited to eight. For example, three, four or six plate springs may be attached to the outer lateral side of holder base 36, and it is preferable that the three, four or six plate springs be arranged at regular angular intervals of 120, 90 or 60 degrees, respectively.

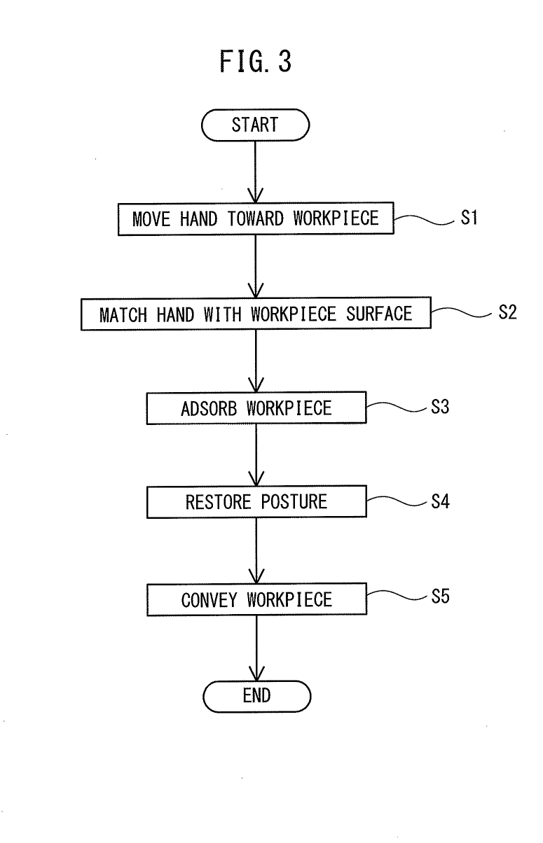

Next, an example of a handling procedure of workpiece 16 using robot hand 10 will be explained with reference to a flowchart of FIG. 3. First, robot hand 10 approaches workpiece 16 (in the example of FIG. 2, robot hand 10 moves downward) (step S1), and an operation (or surface matching) for matching hand 10 (concretely, adsorbing surface 22 of electrical magnet 20) with adsorbed surface 18 of workpiece 16 (step S2).

In this regard, electrical magnet 20 is integrated with connecting member 32, in which the posture of connecting member 32 relative to holder 26 (or hand base 24) can be changed by spherical bearing 28. Therefore, even when robot hand 10 approaches workpiece 16 while adsorbing surface 22 of electrical magnet 20 is not parallel to adsorbed surface 18 of workpiece 16, the posture of electrical magnet 20 is automatically changed by contacting electrical magnet 20 to workpiece 16, whereby the surface matching can be appropriately carried out.

In the next step S3, workpiece 16 is adsorbed to electrical magnet 20 by the magnetic force thereof. Then, by moving hand 10 (in the example of FIG. 2, in the upper direction), the posture of electrical magnet 20 (or connecting member 32) relative to holder 26, which was changed when the adsorbing, is restored to a neutral posture by the restoring force of plate springs 38, in which a center axis of protruding portion 30 coincides with the hand center axis (step S4).

After that, workpiece 16 is conveyed to a predetermined destination by robot hand 10 (step S5). Therefore, when the workpiece is conveyed, the posture of workpiece 16 relative to robot hand 10 can always be constant, whereby the handling of the workpiece (e.g., delivering the workpiece to the next process) at the destination can be facilitated.

When a plurality of workpieces should be adsorbed or held by robot hand 10, these workpieces may be positioned at predetermined places (e.g., the workpieces may be aligned). Otherwise, the workpieces may be randomly located in a container, etc. In particular, in the latter case, the appropriate surface matching can be automatically carried out without precisely controlling the posture of the hand when approaching each workpiece. Further, after the workpiece is adsorbed and moved away from the container, etc., the posture of the hand is automatically restored to the neutral posture. Therefore, the robot hand of the embodiment is particularly advantageous when the workpieces are randomly located.

According to the present invention, even when the orientation of the adsorbing surface of the robot hand is variously changed, the adsorbing surface can be easily matched with the adsorbed surface of the workpiece. Further, by using the plate spring as the posture restoring member, the workpiece can be adsorbed or held without using the air actuator or the electrical actuator. By arranging the plurality of plate springs so that the restoring force functions in any of the different eight directions, compliance of the robot hand can be further improved.

While the invention has been described with reference to specific embodiments chosen for the purpose of illustration, it should be apparent that numerous modifications could be made thereto, by a person skilled in the art, without departing from the basic concept and scope of the invention.

1. A robot hand configured to match an adsorbing surface of an electrical magnet with an adsorbed surface of a workpiece and adsorb the workpiece so as to hold the workpiece, the robot hand comprising:
a hand base;
a holder attached to the hand base;
a spherical bearing arranged in the holder so that a rotational center of the spherical bearing is positioned on a hand center axis of the hand;
a connecting member attached to the holder via the spherical bearing so that a posture of the connecting member relative to the holder can be changed, the connecting member having a protruding portion which protrudes from the holder in a direction opposed to the hand base with respect to the holder; and
a holder base fixed to an attachment portion of the electrical magnet opposed to the adsorbing surface,
wherein the protruding portion of the connecting member is attached to the holder base so that the connecting member is integrated with the electrical magnet via the holder base, and
wherein a posture restoring member is provided to the holder base, the posture restoring member being configured to restore a posture of the holder base so that the holder base represents a neutral posture in which a center axis of the protruding portion of the connecting member coincides with the hand center axis.

2. The robot hand as set forth in claim 1, wherein the posture restoring member has a plate spring.

3. The robot hand as set forth in claim 1, wherein the posture restoring member has a plurality of plate springs configured to generate a restoring force in either of eight directions different from each other.

4. A robot comprising the robot hand as set forth in claim 1.
